(19) United States
(12) Patent Application Publication
(10) Pub. No.: US 2021/0129208 A1
(43) Pub. Date: May 6, 2021

(54) APPARATUS AND METHODS FOR INSTALLING COMPOSITE RIVETS

(71) Applicant: BOMBARDIER INC., Dorval (CA)

(72) Inventors: Louis LABERGE LEBEL, Montreal (CA); Vincent FORTIER, (CA)

(21) Appl. No.: 16/491,777

(22) PCT Filed: Mar. 19, 2018
(86) PCT No.: PCT/IB2018/051448

§ 371 Date: Sep. 6, 2019

Related U.S. Application Data
(60) Provisional application No. 62/469,211, filed on Mar. 9, 2017.
(60) Provisional application No. 62/491,537, filed on Apr. 28, 2017.

(51) Int. Cl. B21J 15/04; B29C 65/60; B29C 65/00; B29C 65/08; B29C 65/36

(52) U.S. Cl. CPC B21J 15/04; B29C 65/601; B29L 2031/3076; B29C 65/08; B29C 65/36; B29C 66/7212

(57) ABSTRACT

Apparatus and methods for installing composite rivets are disclosed. One disclosed method comprises: inserting a composite rivet blank comprising a composite material into a hole in a part; heating the composite rivet blank using Joule heating while the composite rivet blank is in the hole; and then finishing the composite rivet blank.

### CROSS-REFERENCE TO RELATED APPLICATION(S)

The present application claims priority to U.S. Provisional Patent Application Nos. 62/469,211 filed on Mar. 9, 2017 and 62/491,537 filed on Apr. 28, 2017, the entire contents of which are hereby incorporated by reference.

### TECHNICAL FIELD

The disclosure relates generally to composite materials and more particularly to the installation of composite fasteners useful in fastening parts comprising composites or other materials.

### BACKGROUND OF THE ART

Fiber-reinforced polymeric resin composite materials are becoming more widely used in aircraft structures due to their strength-to-weight characteristics. Current fastening methods for securing composite parts together can require relatively complicated tooling and procedures. For example, titanium fasteners have been used to secure composite parts but such fasteners are relatively expensive. Also, due to the material and mechanical properties of composite materials, the use of titanium fasteners requires advanced drilling techniques to avoid or minimize stress concentrations in the composite parts. Alternatively, the use of aluminum fasteners may not be appropriate for securing parts made of composite materials due to compatibility issues that may result in galvanic corrosion between the aluminum and carbon in the composite material.

For aircraft applications, the use of electrically conductive metallic fasteners in composite materials with a relatively low electrical conductivity can also cause some concerns associated with electromagnetic interference (EMI) and lightning strike protection.

### SUMMARY

In one aspect, the disclosure describes a method for installing a composite rivet. The method comprises:
inserting a composite rivet blank comprising a composite material into a hole in a part;
heating the composite rivet blank using Joule heating while the composite rivet blank is in the hole; and then
finishing the composite rivet blank.

The method may comprise: heating the composite rivet blank so that a temperature of a first portion of the composite rivet blank is higher than a temperature of a second portion of the composite rivet blank; and then finishing the first portion of the composite rivet blank.

The method may comprise: heating the composite rivet blank so that the temperature of the second portion of the composite rivet blank is higher than the temperature of the first portion of the composite rivet blank; and then finishing the second portion of the composite rivet blank.

The method may comprise: heating the composite rivet blank using Joule heating while a cooling capacity associated with a first portion of the composite rivet blank is higher than a cooling capacity associated with a second portion of the composite rivet blank; and then finishing the second portion of the composite rivet blank.

The method may comprise: heating the composite rivet blank using Joule heating while the cooling capacity associated with the second portion of the composite rivet blank is higher than the cooling capacity associated with the first portion of the composite rivet blank; and then finishing the first portion of the composite rivet blank.

The method may comprise changing the cooling capacity associated with the first portion of the composite rivet blank by changing an amount of surface area of the first portion coupled to a first heat sink.

The method may comprise changing the cooling capacity associated with the second portion of the composite rivet blank by changing an amount of surface area of the second portion coupled to a second heat sink.

The method may comprise driving an electric current through the composite rivet blank to cause Joule heating of the composite rivet blank.

The method may comprise using induction heating to cause Joule heating of the composite rivet blank.

The method may comprise: using induction heating to heat a first portion of the composite rivet blank separately from a second portion of the composite rivet blank; and then finishing the first portion of the composite rivet blank.

The method may comprise: using induction heating to heat the second portion of the composite rivet blank separately from the first portion of the composite rivet blank; and then finishing the second portion of the composite rivet blank.

The method may comprise at least partially finishing the composite rivet blank while the composite rivet blank is heated using Joule heating.

The method may comprise applying ultrasonic energy to one or more tools for finishing the composite rivet blank while finishing the composite rivet blank.

Embodiments may include combinations of the above features.

In another aspect, the disclosure describes a method for installing a composite rivet using deformation of a composite rivet blank. The method comprises:
inserting the composite rivet blank comprising a composite material into a hole in a part;
heating the composite rivet blank by causing heat to be generated from within a first portion of the composite rivet blank while the composite rivet blank is in the hole and before deforming the first portion of the composite rivet blank; and then
finishing the first portion of the composite rivet blank by deforming the first portion of the composite rivet blank.

The method may comprise: heating the composite rivet blank by causing heat to be generated from within a second portion of the composite rivet blank while the composite rivet blank is in the hole and before deforming the second portion of the composite rivet blank; and then finishing the second portion of the composite rivet blank by deforming the second portion of the composite rivet blank.

The method may comprise causing heat to be generated from within the first and second portions of the composite rivet blank substantially simultaneously.

The method may comprise finishing the first and second portions of the composite rivet blank substantially simultaneously.

The method may comprise finishing the first and second portions of the composite rivet blank at different times.

The method may comprise cooling the second portion of the composite rivet blank while heat is being generated from within the first portion of the composite rivet blank so that the first portion is hotter than the second portion.

The method may comprise cooling the first portion of the composite rivet blank while heat is being generated from within the second portion of the composite rivet blank so that the second portion is hotter than the first portion.

The method may comprise causing heat to be generated from within the composite rivet blank using Joule heating.

The method may comprise applying ultrasonic energy to one or more tools for finishing the composite rivet blank while finishing the composite rivet blank.

Embodiments may include combinations of the above features.

In a further aspect, the disclosure describes an apparatus for installing a composite rivet comprising a composite material. The apparatus may comprise:
a first finishing tool configured to be positioned on a first side of a part into which a composite rivet blank has been inserted and finish a first portion of the composite rivet blank;
a second finishing tool configured to be positioned on a second side of the part into which the composite rivet blank has been inserted and finish a second portion of the composite rivet blank; and
a power supply configured to couple with the composite rivet blank when the composite rivet blank is inserted in the part and heat the composite rivet blank using Joule heating.

The first finishing tool may comprise a heat sink configured to selectively change a cooling capacity associated with the first portion of the composite rivet blank.

The first finishing tool may comprise a heat sink that is movable relative to the composite rivet blank to selectively change an amount of surface area of the first portion coupled to the heat sink.

The first finishing tool may comprise a ram for applying pressure to the first portion of the composite rivet blank, and, a bucking tool for forming part of the first portion of the composite rivet blank. The bucking tool may comprise an opening for movably receiving the ram and the composite rivet blank therein. The heat sink may comprise the bucking tool.

The power supply may comprise an electric current source electrically coupled to the ram and to the second finishing tool for driving electric current through the composite rivet blank.

The bucking tool may be electrically insulated from the ram.

The power supply may comprise an electric current source.

The power supply may be part of an induction heater.

The first finishing tool may comprise a ram for applying pressure to the composite rivet blank, and, a bucking tool for forming part of the first portion of the composite rivet blank. The bucking tool may comprise an opening for movably receiving the ram and the composite rivet blank therein. The power supply may comprise an induction coil embedded into the bucking tool.

The apparatus may comprise a first induction coil for coupling with the first portion of the composite rivet blank, and, a second induction coil for coupling with the second end portion of the composite rivet blank.

The apparatus may comprise an ultrasonic generator coupled to the first finishing tool, to the second finishing tool, or, to both the first finishing tool and the second finishing tool.

The first finishing tool may comprise a first ram for applying pressure to the composite rivet blank where the first ram is movable relative to a first part of the first finishing tool configured to contact the part. The second finishing tool may comprise a second ram for applying pressure to the composite rivet blank where the second ram is movable relative to a second part of the second finishing tool configured to contact the part.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a schematic perspective view of an exemplary composite rivet blank;

FIG. 1B is a schematic representation of an exemplary braid structure of yarns of reinforcement fibers that may be embedded inside the blank of FIG. 1A;

FIG. 2 is a schematic cross-sectional view of an exemplary apparatus for installing a composite rivet; and

FIG. 3 is a flow chart illustrating an exemplary method for installing a composite rivet;

FIGS. 4A-4C are schematic diagrams graphically illustrating an exemplary embodiment of the method of FIG. 3;

FIG. 5 is a cross-sectional view of a structural assembly comprising a rivet formed using the blank of FIG. 1A;

FIGS. 6A-6E are schematic diagrams graphically illustrating another exemplary embodiment of the method of FIG. 3; and

FIGS. 7A-7C are schematic diagrams graphically illustrating another exemplary embodiment of the method of FIG. 3 using another exemplary apparatus for installing a composite rivet.

### DETAILED DESCRIPTION

The present disclosure relates to the installation of fasteners comprising composite materials. In various embodiments, the present disclosure discloses apparatus and methods that facilitate the installation of composite rivets that are made from composite materials. The apparatus and methods disclosed herein may be suitable for use with composite rivet blanks as disclosed in International Patent Publication No. WO 2015/132766 (title: COMPOSITE RIVET BLANK AND INSTALLATION THEREOF), which is incorporated herein by reference. The apparatus and associated methods disclosed herein may be used to secure parts together including parts comprising composite materials, metallic material(s), ceramics and/or plastics. The apparatus and associated methods disclosed herein may also be used in hybrid structures comprising metallic and composite materials. The apparatus and associated methods disclosed herein may be used in aircraft, automotive and/or other applications. In some embodiments, the installation of composite rivets as disclosed herein may alleviate, at least in part, some concerns associated with conventional metallic fasteners used in composite parts with respect to electromagnetic interference shielding and electrostatic discharge inside aircraft and/or galvanic corrosion of dissimilar materials.

In some embodiments, the apparatus and methods disclosed herein may facilitate the installation of composite rivets that require heating so that one or more ends of a composite rivet blank may be finished by deformation (e.g., thermoformed). In various embodiments, the apparatus and methods disclosed herein may facilitate the handling and finishing of the composite rivet blank by heating of the composite rivet blank after the composite rivet blank has been inserted in one or more parts (i.e., in-situ). In various embodiments, the apparatus and methods disclosed herein may make use of Joule heating of the composite rivet blank to cause heat to be generated inside of the composite rivet blank.

Aspects of various embodiments are described through reference to the drawings.

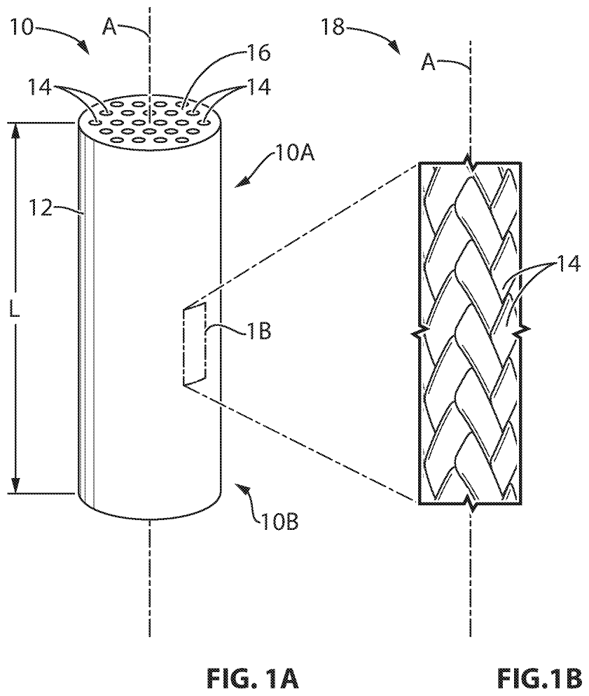

FIG. 1A is a schematic perspective view of an exemplary composite fastener (e.g., rivet) blank 10 (referred hereinafter as “blank 10”). Blank 10 may be a precursor to a suitable fastener for securing two or more parts together. The function of the fastener obtained with blank 10 may, in some embodiments, have similarities to that of conventional rivets and accordingly may be referred as a “rivet” in the present application. However, the term “rivet” is not intended to limit the geometry, structure or function of the fasteners or blanks disclosed herein. Blank 10 may comprise elongated body 12 having longitudinal axis A and length L. Body 12 may have a generally cylindrical shape. For example, body 12 may have a generally circular transverse cross-section but body 12 could also have other cross-sectional shapes. In various embodiments, body 12 may have a substantially uniform cross-section along length L but body 12 could also have a cross-sectional shape and/or size that varies along its length L.

Body 12 may comprise a consolidation of reinforcement fibers in the form of yarns 14 embedded in a suitable matrix material 16. Matrix material 16 may serve to hold the reinforcement fibers together in the desired shape, protect the reinforcement fibers and distribute loads through the reinforcement fibers. In various embodiments, matrix material 16 may comprise a suitable thermoplastic or other thermo-formable material(s). For example, matrix material 16 may comprise one or more of the following: Nylon such as polyamide (PA), polyetherimide (PEI), polyethersulfone (PES), polyphenylene sulfide (PPS), polyetheretherketone (PEEK) and polyetherketoneketone (PEKK). While the exemplary embodiments described and shown in the present disclosure are mainly directed to the use of thermo-formable materials such as thermoplastics, other types of materials may be suitable for use as matrix material 16. In some embodiments, matrix material 16 in blank 10 may, for example, include a thermosetting material such as a B-staged thermoset resin which may be softened by the application of heat and formed accordingly during installation of blank 10.

Reinforcement fibers used in yarns 14 may, for example, comprise any suitable material typically used in the reinforcement of composite materials such as carbon filaments, glass filaments covered with an electrically conductive coating and/or ceramic filaments covered with an electrically conductive coating. Yarns 14 may not necessarily comprise reinforcement fibers of all the same material. For example, yarns 14 may comprise reinforcement fibers of different materials to achieve desired material and mechanical properties. In some embodiments, different yarns 14 may comprise reinforcement fibers of different materials. In some embodiments, the reinforcement fibers may be continuous or be discontinuous and optionally of different lengths.

FIG. 1B is a schematic representation of an exemplary braid structure 18 of yarns 14 that may be embedded inside blank 10. FIG. 1B may represent yarns 14 in region 1B of blank 10 shown in FIG. 1A. In various embodiments, at least some of yarns 14 may follow a path where at least part of the path has an orientation that is non-parallel to axis A of body 12.

The embodiment of blank 10 illustrated in FIGS. 1A and 1B is exemplary only and it is understood that other configurations of blank 10 may be used in conjunction with the apparatus and methods disclosed here. For example, blank 10 may be made from a composite material comprising two or more constituent materials with different properties. In some embodiments, blank 10 may be made from a composite material where at least one of its constituents is susceptible to Joule heating, also known as ohmic heating and resistive heating, whereby heat is produced by an electric current. In some embodiments, blank 10 may comprise a reinforced plastic. In some embodiments, blank 10 may comprise a fiber-reinforced polymer. In some embodiments, one or more constituents (e.g., fibers, particles, matrix material) of the composite material from which blank 10 is formed may have an electrical conductivity that is suitable for Joule heating so that heat may be generated inside of the blank 10 by way of such constituent(s) serving as one or more heating elements.

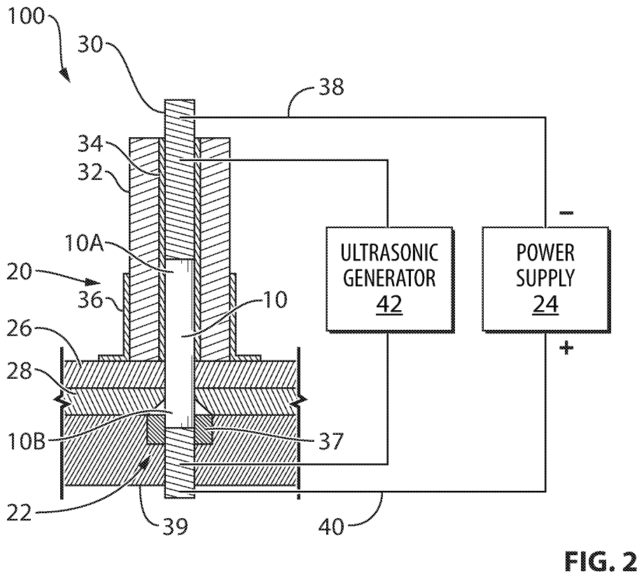

FIG. 2 is a schematic cross-sectional view of an exemplary apparatus 100 for installing a composite rivet comprising a composite material. In various embodiments, apparatus 100 may comprise first finishing tool 20, second finishing tool 22 and power supply 24. First finishing tool 20 may be configured to be positioned on a first side of a part (e.g., panels 26, 28) into which composite rivet blank 10 has been inserted and at least assist in finishing first portion 10A of composite rivet blank 10. Second finishing tool 22 may be configured to be positioned on a second (e.g., opposite) side of the part into which composite rivet blank 10 has been inserted and at least assist in finishing second portion 10B of composite rivet blank 10. Even though apparatus 100 is configured to finish both ends/portions 10A, 10B, it is understood that aspects of the present disclosure are also applicable to the installation of rivets where one end/portion of blank 10 is already in a finished state prior to insertion into panels 26, 28 and that only one end/portion (e.g., 10A or 10B) of blank 10 needs to be finished after insertion of blank 10 into panels 26, 28.

Power supply 24 may be configured to be coupled to blank 10 when blank 10 is inserted in the part (e.g., panels 26, 28) and cause heat to be generated inside of composite rivet blank 10 prior to and/or during deformation of blank 10. In various embodiments, coupling of power supply 24 to blank 10 may comprise any suitable way or transferring energy to blank 10 in order to cause heat to be generated from within blank 10 instead of heat being generated outside of blank 10 and subsequently transferred (e.g., by conduction) to blank 10. Accordingly, generating heat from within blank 10 may reduce or eliminate the need for neighboring components (e.g., finishing tools 20, 22 and/or panels 26, 28) to be actively heated in order to transfer heat to blank 10. Heating blank 10 after insertion into panels 26, 28 (i.e., in-situ) may also reduce or eliminate the need for handling blank 10 in a heated state outside of panels 26, 28. In some embodiments, power supply 24 may comprise an electric current source for driving an electric current through blank 10, generally along axis A shown in FIG. 1A. Power supply 24 may be electrically coupled to blank 10 via parts of first finishing tool 20 and second finishing tool 22 which may be in direct contact with blank 10.

First finishing tool 20 may comprise ram 30 for applying pressure to first portion 10A of blank 10 for finishing first portion 10A of blank 10 and, in some embodiments, for assisting with the finishing of second portion 10B of blank 10 also. First finishing tool 20 may comprise bucking tool 32 for forming part of first portion 10A of blank 10. Bucking tool 32 may comprise an opening extending therethrough for movably receiving ram 30 and blank 10 therein. In some embodiments, bucking tool 32 may have a sleeve-like configuration. Ram 30 may be vertically movable relative to bucking tool 32 and bucking tool 32 may similarly also be vertically movable relative to ram 30 in relation to the orientation shown in FIG. 2. Ram 30 and bucking tool 32 may be made from suitable metallic material(s) such as (e.g., AISI 4140) steel for example.

In some embodiments, bucking tool 32 may be electrically insulated from ram 30 via insulator 34. Insulator 34 may comprise a liner (e.g., bushing) interposed between ram and bucking tool 32. Insulator 34 may comprise a material with a relatively low electrical conductivity. In some embodiments, insulator 34 may comprise an alumina-ceramic material or other material with suitable (e.g., thermal, electrical and/or wear) properties. In some embodiments, insulator 34 may be bonded to bucking tool 32 in the form of a coating so that insulator 34 may move together with bucking tool 32 as a unit and may be considered part of bucking tool 32. The material and thickness of insulator 34 may be selected so that insulator 34 is still sufficiently thermally conductive in order to permit bucking tool 32 to serve as a suitable heat sink into which heat from blank 10 may be conductively transferred in some situations as explained below.

First finishing tool 20 may also comprise bucking tool socket 36 inside which bucking tool 32 may be received. As illustrated below, bucking tool socket 36 may also cooperate with bucking tool 32 and ram 30 in finishing first portion 10A of blank 10. In some embodiments, bucking tool socket 36 may comprise a thermally and electrically insulating material. In some embodiments, bucking tool socket 36 may, for example, be made from the same type of material as insulator 34.

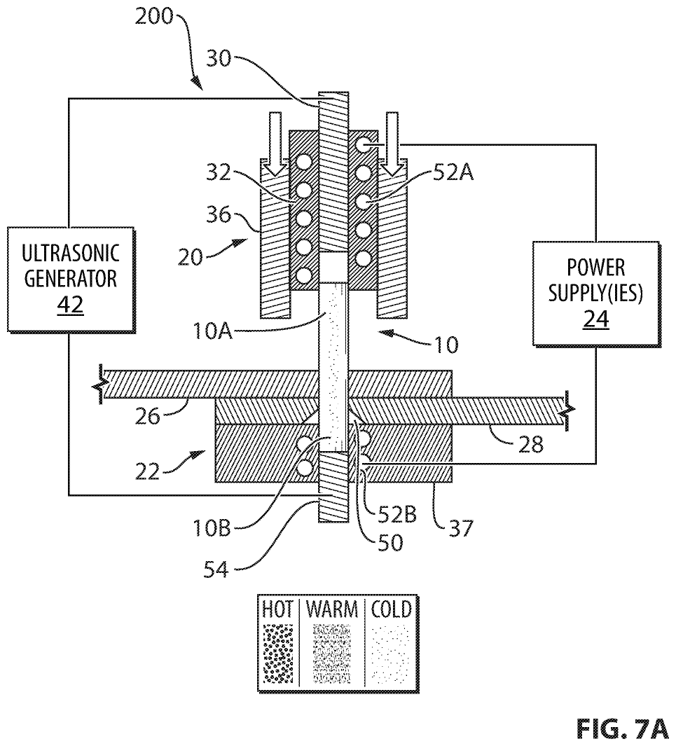

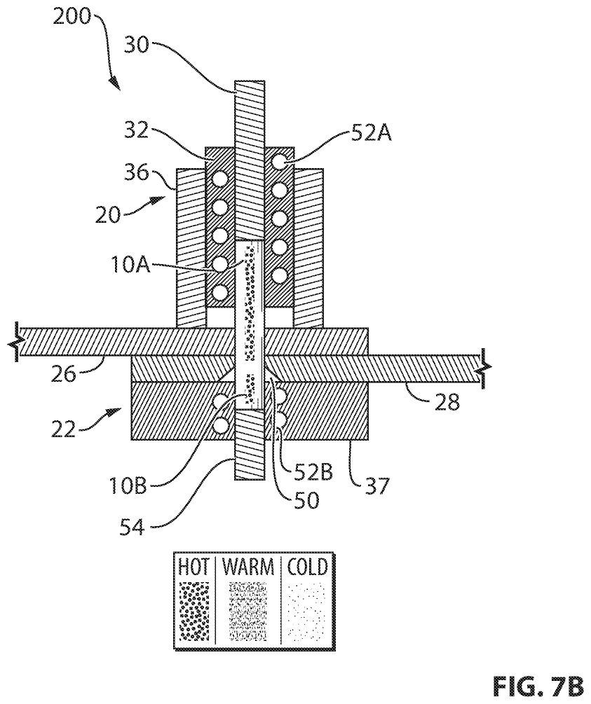

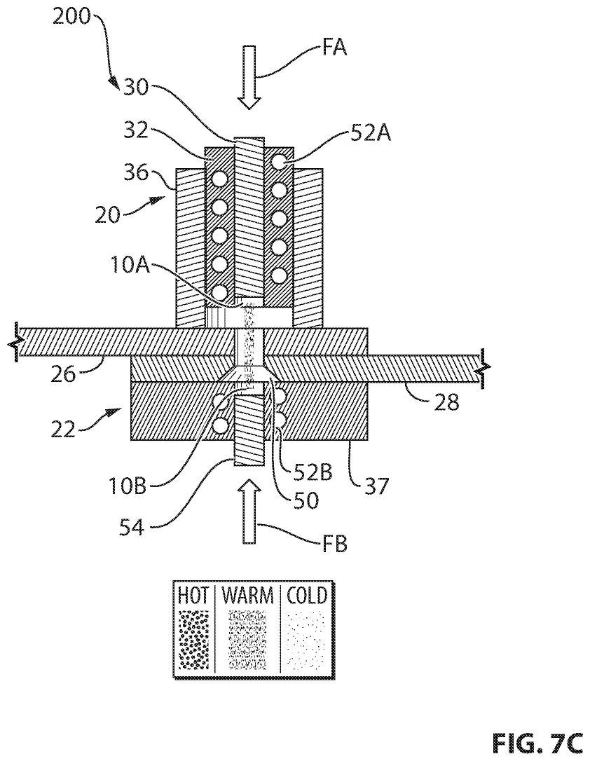

Second finishing tool 22 may comprise a suitable backing support for blank 10 during the finishing of blank 10. Second finishing tool 22 may be in contact with second portion 10B of blank 10. In cases where second portion 10B of blank 10 is in a finished state prior to inserting blank 10 into panels 26 and 28, second finishing tool 22 may simply support blank 10 when first portion 10A of blank 10 is finished by lowering ram 30 to apply a pressure onto blank 10. However, in cases where second portion 10B of blank 10 is not in a finished state prior to insertion into panels 26 and 28, second finishing tool 22 may be configured to serve as a die for forming second portion 10B into a desired shape when second portion 10B of blank 10 is finished by lowering ram 30 to apply a pressure onto blank 10. Second finishing tool 22 may be made from suitable metallic material(s) such as (e.g., AISI 4140) steel for example. In some embodiments, part(s) (e.g., base 37) of second finishing tool 22 may be separately heated to facilitate the finishing of second portion 10B. In some embodiments, second finishing tool 22 may be configured as a fixed forming die during finishing of blank 10 or may comprise a movable ram such as ram 54 shown in FIGS. 7A-7C. In some embodiments, second finishing tool 22 may be supported by a suitable support structure 39 which may be made from a suitable material having relatively high thermally and electrically insulating properties.

Power supply 24 may be electrically coupled to blank 10 via ram 30 of first finishing tool 20 and second finishing tool 22 which may be in direct contact with blank 10. Ram 30 and second finishing tool 22 may be made from (e.g., metallic) material(s) having a good or relatively high electrical conductivity and may serve as electrodes electrically coupled to power supply 24 for driving (e.g., direct or alternating) electric current through blank 10 generally along axis A (see FIG. 1A). For example, ram 30 may serve as a negative electrode connected to a negative terminal of power supply 24 via conductor 38 and second finishing tool 22 may serve as a positive electrode connected to a positive terminal of power supply 24 via conductor 40. Driving electric current through blank 10 may cause heat to be generated within blank 10 by way of Joule heating and may cause a temperature of blank 10 to rise. Such Joule heating may be used to heat blank 10 or portions thereof to temperatures suitable for finishing first portion 10A and/or second portion 10B. Such suitable temperature may be a processing temperature of one of the constituents (e.g., matrix 16) of the composite material of blank 10. In some embodiments, such temperature may be sufficiently high so that the viscosity of matrix 16 is sufficiently low to permit forming (e.g., thermoforming) of first portion 10A and/or of second portion 10B of blank 10.

In some embodiments, apparatus 100 may comprise ultrasonic generator 42 or other type of vibration generator coupled to first finishing tool 20 and/or to second finishing tool 22 for the purpose of applying ultrasonic energy to first finishing tool 20 and/or to second finishing tool 22 or part(s) thereof. In various embodiments, ultrasonic generator 42 may be coupled to ram 30, bucking tool 32 and/or bucking tool socket 36. The use of ultrasonic generator 42 may permit apparatus 100 to perform an ultrasonically-assisted finishing operation of blank 10. In some situations, the application of such ultrasonic energy may provide one or more of the following advantages: reduced friction between blank 10 and finishing tools 20, 22; improved material flow during finishing of blank 10; reduced force required by ram 30 for finishing blank 10; and improved surface finish of the rivet formed from blank 10.

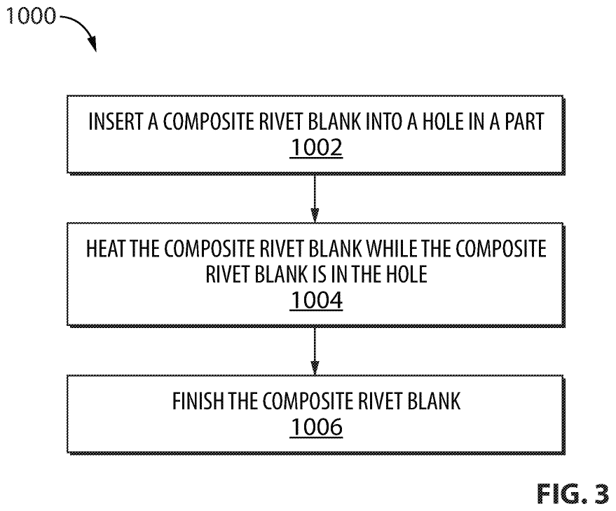

FIG. 3 is a flow chart illustrating an exemplary method 1000 for installing a composite rivet. Method 1000 may be performed using an apparatus as disclosed herein such as apparatus 100 or apparatus 200 described further below. In various embodiments, method 1000 may comprise: inserting blank 10 into a hole in a part (see block 1002); heating blank 10 (e.g., using Joule heating) while the blank 10 is in the hole (see block 1004); and finishing blank 10 (see block 1006).

Even though portions 10A, 10B of blank 10 are referred to as “first” portion 10A and “second” portion 10B, the terms “first” and “second” are only used to distinguish one portion of blank 10 from another. The terms “first” and “second” do not represent an order in which portions 10A, 10B must be finished. In various embodiments of method 1000, either first portion 10A or second portion 10B may be finished first and the other of first portion 10A and second portion 10B may be finished after. In some embodiments of method 1000, first portion 10A and second portion 10B may be finished substantially simultaneously. In some embodiments of method 1000, either first portion 10A or second portion 10B may already be in a finished condition prior to insertion into panels 26, 28 and therefore only the other of first portion 10A and second portion 10B may require finishing. Finishing of blank 10 may comprise deforming (i.e., upsetting) of one or more portions (e.g., 10A and/or 10B) and causing a change in the geometry of blank 10.

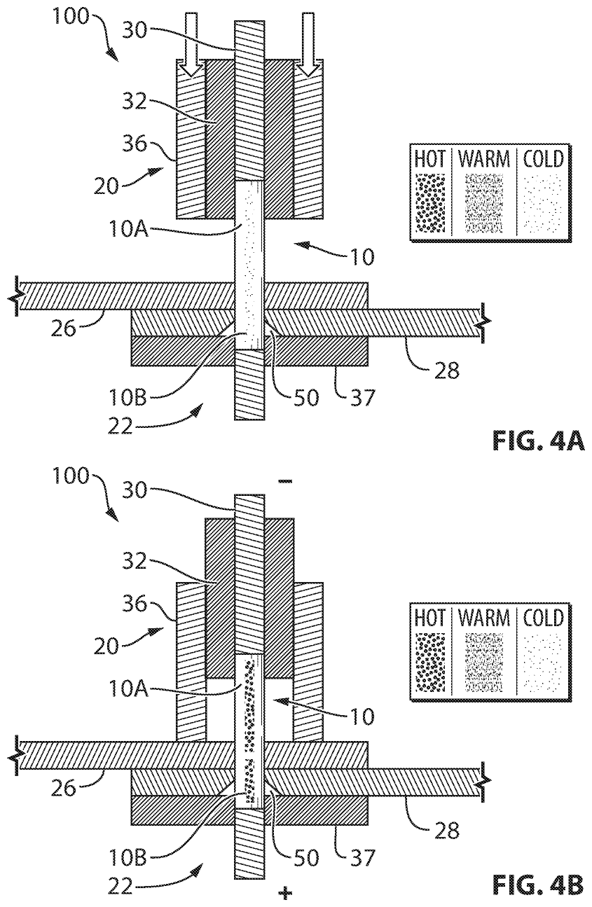

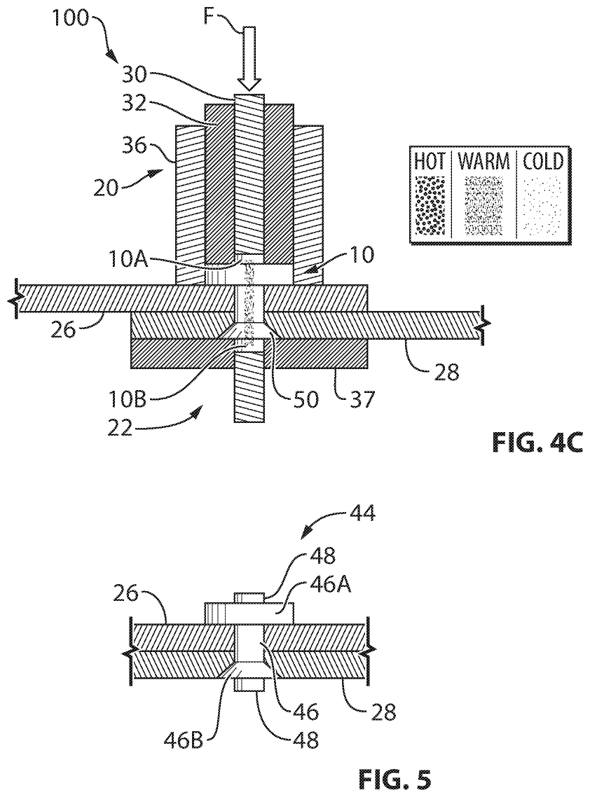

FIGS. 4A-4C are schematic diagrams graphically illustrating an exemplary embodiment of method 1000 of FIG. 3. FIGS. 4A-4C show apparatus 100 as described above having different configurations representing different stages of installation of a rivet using blank 10. Some components (e.g., insulator 34, power supply 24, support structure 39 and ultrasonic generator 42) of apparatus 100 have been omitted from FIGS. 4A-4C for the sake of clarity.

FIG. 4A shows a configuration of apparatus 100 where blank 10 has just been inserted into panels 26, 28 and has not yet been significantly heated or finished. Blank 10 is shown as being entirely “cold” which may represent an initial temperature (e.g., at room temperature, hotter than room temperature or cooler than room temperature) of blank 10 prior to any active heating using power supply 24. In some embodiments, blank 10 could be heated by other means to an initial temperature that is lower than its processing temperature before insertion into panels 26 and 28 and before heating using power supply 24.

First finishing tool 20 is shown as being on one side of panels 26, 28 to be joined and second finishing tool 22 is shown as being on an opposite side of panels 26, 28. First portion 10A of blank 10 is shown as being engaged with first finishing tool 20 and second portion 10B of blank 10 is shown as being engaged with second finishing tool 22. Panel 28 may provide countersink 50 to facilitate the forming of second portion 10B of blank 10 during finishing of blank 10. In some embodiments, panel 26 may alternatively or in addition provide a countersink to facilitate the forming of first portion 10A of blank 10. In some embodiments, both first portion 10A and second portion 10B may be finished without the use of countersinks. In some embodiments, panel 26 and/or panel 28 may be provided with feature(s) (e.g., counterbore) of any suitable shape that may facilitate the forming of first portion 10A and/or second portion 10B of blank 10.

FIG. 4B shows a subsequent configuration of apparatus 100 where bucking tool socket 36 has been advanced (e.g., lowered) onto panel 26. Bucking tool socket 36 and second finishing tool 22 may cooperatively apply a compressive force onto panels 26 and 28 for the purpose of pressing panels 26 and 28 together prior to and also during the finishing of blank 10 to provide a firm joint between panels 26 and 28.

FIG. 4B also shows blank 10 being heated to a “hot” temperature which may be sufficiently high to permit finishing of blank 10 as explained above. Heating of blank 10 may be achieved by driving an electric current through (e.g., along) blank 10 using power supply 24, which may be a suitable current source in this case. Ram 30 is shown as having a negative polarity associated with power supply 24 and second finishing tool 22 is shown as having a positive polarity associated with power supply 24. In this embodiment of method 1000, both first portion 10A and second portion 10B of blank 10 may be heated to a hot temperature so that they may be finished substantially simultaneously. For example, both first portion 10A and second portion 10B may be finished with a substantially continuous stroke of ram 30. Alternatively, in a case where second finishing tool 22 would comprise a movable ram such as ram 54 from FIGS. 7A-7B, both first portion 10A and second portion 10B could be finished by substantially simultaneous movement of ram 30 and the movable ram of second finishing tool 22.

During heating of blank 10, bucking tool 32 may be raised relative to tool socket 36 and at a position away from panel 26 so that they may not provide a significant heat sink for cooling blank 10. Accordingly, since both first portion 10A and second portion 10B of blank 10 may be mainly in contact with air, both first portion 10A and second portion 10B may respectively be associated with relatively low cooling capacities in the configuration shown in FIG. 4B. Consequently, the passage of electric current through blank 10 in this configuration of apparatus 100 may cause heating of both first portion 10A and second portion 10B to the hot temperature. In some embodiments where blank 10 may have a substantially uniform cross-sectional area and substantially uniform electrical resistance along its length, this configuration of apparatus 100 may cause substantially uniform heating of both first portion 10A and second portion 10B. In some embodiments, some heat may be transferred from blank 10 by way of conduction to panels 26 and 28, to first finishing tool 20 and/or to second finishing tool 22. It is understood that the hot temperatures of first portion 10A and of second portion 10B of blank 10 do not necessarily have to be identical to permit finishing of both first portion 10A and second portion 10B.

FIG. 4C shows a configuration of apparatus 100 where both bucking tool 32 and ram 30 have been advanced (e.g., lowered) toward panel 26 with the application of force F for the purpose of finishing both first portion 10A and second portion 10B substantially at the same time. Finishing of first portion 10A may cause first portion 10A to deform and fill a space defined by an outer surface of panel 26, a radially-inner surface of bucking tool socket 36, a bottom end surface of bucking tool 32, a radially-inner surface of bucking tool 32 and a bottom end surface of ram 30. Finishing of second portion 10B may cause second portion 10B to deform and fill a space defined by second finishing tool 22 and countersink 50 of panel 28.

In various embodiments, heating of blank 10 using power supply 24 may be stopped prior to finishing of blank 10 or, alternatively, heating of blank 10 may continue during such finishing and may be stopped only after the finishing of blank 10. In any case, first finishing tool 20 and second finishing tool 22 may remain in the position shown in FIG. 4C until first portion 10A and second portion 10B have sufficiently cooled (e.g., to a “warm” temperature) where the resulting rivet has sufficient strength so that force F, first finishing tool 20 and second finishing tool 22 may be removed. In some embodiments of method 1000 illustrated in FIGS. 4A-4C, ultrasonic generator 42 may be used to apply ultrasonic energy to one or more finishing tools 20, 22 while finishing blank 10. In some embodiments, part(s) of second finishing tool 22 such as base 37 may be separately heated by any suitable means to facilitate the finishing of second portion 10B.

In some embodiments, apparatus 100 may comprise a second movable ram (not shown in FIGS. 4A-4C) integrated in second finishing tool 22 (e.g., see ram 54 in FIGS. 7A and 7B) so that finishing of first portion 10A would comprise advancement of ram 30 and finishing of second portion 10B would comprise advancement of such ram of second finishing tool 22.

FIG. 5 is a cross-sectional view of an exemplary structural assembly 30 comprising panel 26 having a first hole formed therein, panel 28 having a second hole formed therein and composite rivet 46 (i.e., formed from blank 10) securing panel 26 and panel 28 together via the first hole and the second hole. Panel 26 and panel 28 may be positioned relative to each other so that the first hole is at least partially aligned with the second hole. Also composite rivet 46 may comprise a body having braided reinforcement fibers embedded in the body and supported in a matrix material 16 as described above. Composite rivet 46 may comprise first finished end 46A, resulting from finishing of first portion 10A of blank 10 (see FIG. 2), engaged with panel 26. Composite rivet 46 may comprise second finished end 46B, resulting from finishing of second portion 10B of blank 10 (see FIG. 2), engaged with panel 28. In some embodiments, at least one of finished ends 46A, 46B may comprise fiber anchoring artifact 48 which may serve to at least partially control the deformation of the reinforcement fibers inside of composite rivet 46 during finishing (e.g., thermoforming) of the at least one of the finished ends 46A, 46B. Fiber anchoring artifacts 48 may comprise a protrusion extending from each of first finished end 46A and second finished end 46B but other configurations of fiber anchoring artifacts 48 may also be suitable.

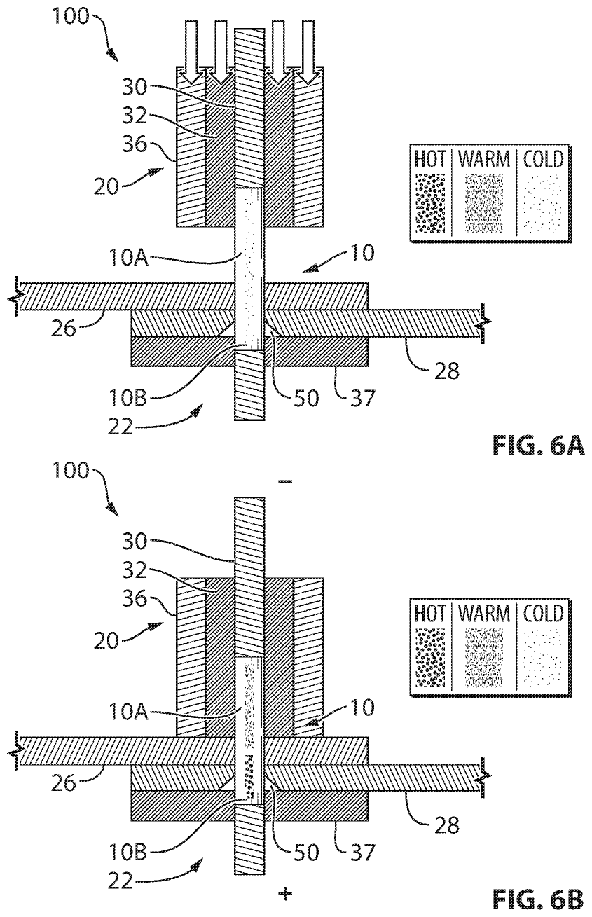

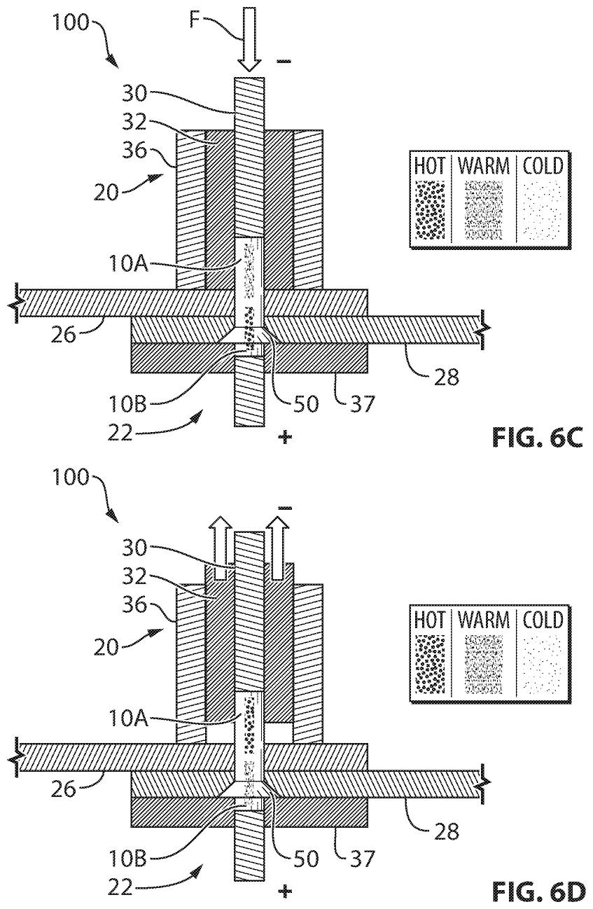

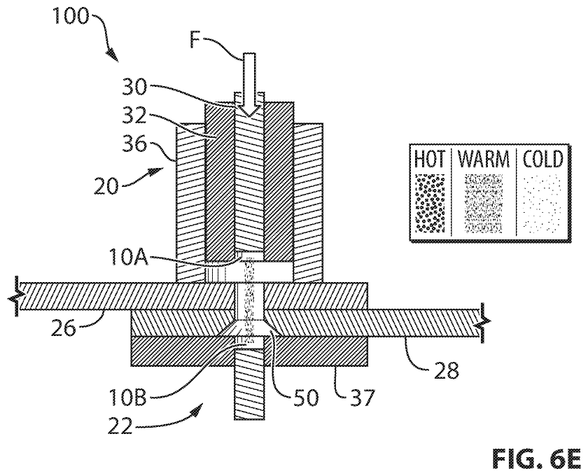

FIGS. 6A-6E are schematic diagrams graphically illustrating another exemplary embodiment of method 1000 of FIG. 3. FIGS. 6A-6E show apparatus 100 as described above having different configurations representing different stages of installation of a rivet using blank 10. Some components (e.g., insulator 34, power supply 24, support structure 39 and ultrasonic generator 42) of apparatus 100 have been omitted from FIGS. 6A-6E for the sake of clarity. In contrast with FIGS. 4A-4C, FIGS. 6A-6E illustrate an embodiment of method 1000 where first portion 10A and second portion 10B of blank 10 are finished sequentially in a stepwise manner as opposed to simultaneously.

FIG. 6A shows a configuration of apparatus 100 where blank 10 has just been inserted into panels 26, 28 and has not been heated or finished yet. Blank 10 is shown as being entirely at a cold/initial temperature prior to any active heating using power supply 24. First finishing tool 20 is shown as being on one side of panels 26, 28 to be joined and second finishing tool 22 is shown as being on an opposite side of panels 26, 28. First portion 10A of blank 10 is shown as being engaged with first finishing tool 20 and second portion 10B of blank 10 is shown as being engaged with second finishing tool 22.

FIG. 6B shows a subsequent configuration of apparatus 100 where bucking tool socket 36 and bucking tool 32 have been advanced (e.g., lowered) onto panel 26. Bucking tool socket 36 and second finishing tool 22 may apply a compressive force onto panels 26 and 28 for the purpose of pressing panels 26 and 28 together prior to and also during the finishing of blank 10 to provide a firm joint between panels 26 and 28. FIG. 6B also shows blank 10 being heated by driving an electric current through blank 10 using power supply 24. Ram 30 is shown as having a negative polarity associated with power supply 24 and second finishing tool 22 is shown as having a positive polarity associated with power supply 24.

Blank 10 may be heated so that a temperature of second portion 10B of blank 10 is higher than a temperature of first portion 10A, and then second portion 10B may be finished first. Such heating may comprise (e.g. Joule) heating of blank 10 by driving current therethrough while a cooling capacity associated with first portion 10A of blank 10 is higher than a cooling capacity associated with second portion 10B of blank 10. The higher cooling capacity associated with first portion 10A of blank 10 may be achieved by bucking tool 32 being lowered and coupled (e.g., in thermal contact via insulator 34 shown in FIG. 2) with a relatively large portion of the surface area of first portion 10A of blank 10 to facilitate conductive heat transfer out of first portion 10A of blank 10 and into bucking tool 32. The coupling of the surface area of first portion 10A with bucking tool 32 compared to second portion 10B of blank 10 being mostly surrounded by air in countersink 50 may result in first portion 10A being associated with a higher cooling capacity than that of second portion 10B due to the heat sink effect provided by bucking tool 32. The use of a higher cooling capacity associated with first portion 10A of blank 10 may result in second portion 10B being heated to a higher temperature than first portion 10A when electric current is driven through blank 10. In other words, the local heating of first portion 10A or of second portion 10B of blank 10 may be achieved by selective differential cooling of first portion 10A and second portion 10B of blank 10 while an electric current is driven through blank 10. FIG. 6B shows first portion 10A being heated to a warm temperature while second portion 10B is heated to a hot temperature suitable for finishing of second portion 10B. It is understood that the cooling capacities associated with first portion 10A and second portion 10B may be determined empirically or by way of modeling and simulation to achieve the desired temperatures of first portion 10A and second portion 10B during Joule heating of blank 10.

FIG. 6C shows a configuration of apparatus 100 where second portion 10B has just been finished by advancing ram 30 with the application of force F and where first portion 10A remains unfinished due to bucking tool 32 still being lowered. The finishing of second portion 10B has caused second portion 10B to deform and fill a cavity defined by second finishing tool 22 and countersink 50 of panel 28. FIG. 6C shows electric current still being driven through blank 10 by polarities +/− but it is understood that the electric current could alternatively be stopped just prior to or during finishing of second portion 10B.

FIG. 6D shows a configuration of apparatus 100 where bucking tool 32 has been raised to a finishing position and blank 10 is being heated so that the temperature of first portion 10A of blank 10 is higher than the temperature of second portion 10B to permit finishing of first portion 10A. Such heating may comprise (e.g. Joule) heating of blank 10 by driving current therethrough while a cooling capacity associated with second portion 10B of blank 10 is higher than a cooling capacity associated with first portion 10A of blank 10. The higher cooling capacity associated with second portion 10B of blank 10 may be achieved by second portion 10B being in contact with panel 28 to facilitate conductive heat transfer out of second portion 10B of blank 10 and into panel 28, and, also by bucking tool 32 being raised so that the surface area of first portion 10A of blank 10 thermally coupled to bucking tool 32 is reduced compared to that shown in FIG. 6D.

FIG. 6E shows a configuration of apparatus 100 where ram 30 has been advanced (e.g., lowered) toward panel 26 with the application of force F for the purpose of finishing first portion 10A. Depending on the vertical position of bucking tool 32 during the finishing of second portion 10B of blank 10 as shown in FIG. 6D, ram 30 and bucking tool 32 could be advanced together to the configuration of FIG. 6E during the finishing of first portion 10A of blank 10. Finishing of first portion 10A may cause first portion 10A to deform and fill a space defined by an outer surface of panel 26, a radially-inner surface of bucking tool socket 36, a bottom end surface of bucking tool 32, a radially-inner surface of bucking tool 32 and a bottom end surface of ram 30.

In various embodiments, changing the cooling capacity associated with first portion 10A while blank 10 is heated using Joule heating may be achieved by selectively changing an amount of surface area of first portion 10A that is coupled to a heat sink such as bucking tool 32. For example, bucking tool 32 may be selectively lowered and raised to vary the amount of surface area of first portion 10A that is thermally coupled to bucking tool 32 directly or indirectly via insulator 34 (see FIG. 2).

Similarly, changing the cooling capacity associated with second portion 10B while blank 10 is heated using Joule heating may be achieved by selectively changing an amount of surface area of second portion 10B that is coupled to a heat sink such as panel 28 for example. For example, when unfinished, a smaller or no surface area of second portion 10B may be in contact with panel 28 but when finished, a larger surface area of second portion 10B may be in contact with panel 28 to permit conductive heat transfer from second portion 10B to panel 28.

In some embodiments of method 1000 illustrated in FIGS. 6A-6E, ultrasonic generator 42 may be used to apply ultrasonic energy to one or more finishing tools 20, 22 while finishing blank 10.

FIGS. 7A-7C are schematic diagrams graphically illustrating another exemplary embodiment of method 1000 of FIG. 3 using another exemplary apparatus 200 for installing a composite rivet. Apparatus 200 may have some elements in common with apparatus 100 previously described above and the description of such components is not repeated below. Like elements are identified using like reference numerals. In contrast with apparatus 100, apparatus 200 may be configured to use induction heating for causing Joule heating of blank 10. Accordingly, apparatus 200 may comprise one or more power supplies 24 coupled to one or more induction coils 52A, 52B. Power supply(ies) 24 may be part of one or more induction heaters. In some embodiments, second finishing tool 22 may comprise ram 54 movably received in base 37.

In some embodiments, apparatus 200 may comprise a single induction coil coupled to cause heating of both first portion 10A and second portion 10B where differential heating of first portion 10A and second portion 10B may be achieved by changing cooling capacities as described above in relation to FIGS. 6A-6E to achieve stepwise heating and finishing of first portion 10A and second portion 10B at different times. Alternatively, a single induction coil could also be used to heat both first portion 10A and second portion 10B to hot temperatures simultaneously for the purpose of finishing both first portion 10A and second portion 10B substantially simultaneously as described in relation to FIGS. 4A-4C.

In the embodiment illustrated in FIGS. 7A-7C, two inductions coils 52A and 52B are used to respectively cause localized Joule heating of first portion 10A and second portion 10B separately. In various embodiments of method 1000, induction coils 52A and 52B may be activated together to heat and permit finishing of both first portion 10A and second portion 10B at the same time. Alternatively, induction coils 52A and 52B may be activated separately at different times to heat and permit finishing of first portion 10A and second portion 10B at different times in a stepwise manner.

In some embodiments, induction coil 52A may be integrated with bucking tool 32, which may be made from a suitable ceramic material such as a glass-mica ceramic sold under the trade names MYKROY/MYCALEX or MACOR, or disposed at any other location (e.g., outside of bucking tool 32) for causing heating of first portion 10A of blank 10. In some embodiments, induction coil 52A may instead be similarly integrated with bucking tool socket 36.

Induction coil 52B may be integrated with base 37 of second finishing tool 22, which may also be made from a suitable ceramic material (e.g., MACOR) or disposed at any other location for causing heating of second portion 10B of blank 10. In some embodiments where panel 28 does not have countersink 50, base 37 may define a cavity configured to accommodate and cooperate in forming a second finished end 46B of composite rivet 46 having a different configuration than that shown in FIG. 5. For example, base 37 may be configured to form a second finished end 46B of composite rivet 46 that is external to panel 28 and that has a configuration that is similar to that of first finished end 46A as shown in FIG. 5.

In some embodiments, induction coil 52A may be embedded inside bucking tool 32, which may be made from an electrically non-conductive material (e.g., polymer or ceramic) or from an electrically conductive material. For example, induction coil 52A may be integrated with bucking tool 32 during a molding or casting process used to produce bucking tool 32 or in any other suitable manner. In some embodiments, the material and shape of bucking tool 32 may serve to influence a magnetic field produced by induction coil 52A to focus the heating into blank 10 as opposed to neighboring components. Induction coil 52B may similarly be embedded inside of base 37.

FIG. 7A shows a configuration of apparatus 200 where blank 10 has just been inserted into panels 26, 28 and has not been heated or finished yet. Blank 10 is shown as being entirely at a cold/initial temperature prior to any active heating using power supply(ies) 24 and induction coils 52A, 52B. First finishing tool 20 is shown as being on one side of panels 26, 28 to be joined and second finishing tool 22 is shown as being on an opposite side of panels 26, 28. In some embodiments, bucking tool 32 and bucking tool socket 36 may be integrated into a single part similar to base 37 or may be two separate parts that may be moved separately or together. Bucking tool 32 and bucking tool socket 36 are shown as being moved downwardly together so that bucking tool 32 may engage with first portion 10A of blank 10 and bucking tool socket 36 may engage panel 26. Second portion 10B of blank 10 is shown as being engaged with second finishing tool 22. Power supply(ies) 24 and ultrasonic generator 42 have been omitted from FIGS. 7B and 7C for the sake of clarity.

FIG. 7B shows a subsequent configuration of apparatus 200 where bucking tool socket 36 and bucking tool 32 have been advanced (e.g., lowered) toward panel 26. Bucking tool socket 36 and second finishing tool 22 may cooperatively apply a compressive (i.e., clamping) force onto panels 26 and 28 for the purpose of pressing panels 26 and 28 together prior to and also during the finishing of blank 10 to provide a firm joint between panels 26 and 28.

FIG. 7B also shows blank 10 being heated to the hot temperature which may be sufficiently high to permit finishing of blank 10 as explained above. Heating of blank 10 may be achieved by inducing a current into blank 10 by way of an alternating current being driven in induction coils 52A, 52B by power supply(ies) 24. In this embodiment of method 1000, both first portion 10A and second portion 10B of blank 10 may be simultaneously heated to hot temperatures via induction coils 52A and 52B coupled to respective first portion 10A and second portion 10B of blank 10. However, it is understood that first portion 10A and second portion 10B of blank 10 could instead be heated and finished at different times by the selective activation of induction coils 52A and 52B and of first and second finishing tools 20, 22.

FIG. 7C shows a configuration of apparatus 200 where first portion 10A of blank 10 has been finished by advancing ram 30 with the application of associated force FA and where second portion 10B of blank 10 has been finished by advancing ram 54 with the application of associated force FB. In some embodiments, first portion 10A and second portion 10B may be finished in a stepwise manner at different times by advancing either ram 30 or ram 54 before advancing the other. Alternatively, first portion 10A and second portion 10B may be finished at the same time by advancing ram 30 and ram 54 simultaneously. In various embodiments, ram 30 and/or ram 54 may be advanced by controlling a force exerted by ram 30 and/or ram 54, or, by controlling a displacement of ram 30 and/or ram 54.

In some embodiments of method 1000, bucking tool 32 with its integrated induction coil 52A could be lowered as shown in FIG. 7B for the purpose of causing heating of first portion 10A of blank 10 and then raised relatively rapidly while bucking tool socket 36 remains engaged with panel 26 so that bucking tool 32 and ram 30 may subsequently be lowered together during finishing of first portion 10A.

In some embodiments of method 1000 where induction coil 52A may be integrated with bucking tool socket 36 instead of bucking tool 32, bucking tool 32 may be placed in a raised position as shown in FIG. 7A while bucking tool socket 36 is lowered against panel 26 and induction coil 52A causes heating of first portion 10A of blank. Once first portion 10A of blank 10 is sufficiently heated, bucking tool 32 may be lowered together with ram 30 during finishing of first portion 10A to end up at the configuration shown in FIG. 7C. The raised position of bucking tool 32 during the heating of first portion 10A may reduce the cooling capacity associated with first portion 10A by reducing the heat sink effect that bucking tool 32 may have on first portion 10A. Accordingly, heating of first portion 10A using induction coil 52A integrated with bucking tool socket 36 while bucking tool 32 is raised may allow for more efficient and/or rapid heating in some situations.

In various embodiments, some of the movement of bucking tool 32 may be combined with the movement of bucking tool socket 36 or with the movement of ram 30. In some embodiments, the movement of bucking tool 32, bucking tool socket 36 and ram 30 may be independently controllable to achieve different sequences of operation suitable for finishing first portion 10A of blank 10.

In some embodiments of method 1000 illustrated in FIGS. 7A-7C, ultrasonic generator 42 may be used to apply ultrasonic energy to one or more finishing tools 20, 22 while finishing blank 10.

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

1. A method for installing a composite rivet, the method comprising:
inserting a composite rivet blank comprising a composite material into a hole in a part;
heating the composite rivet blank using Joule heating while the composite rivet blank is in the hole; and then
finishing the composite rivet blank.

2. The method as defined in claim 1, comprising:
heating the composite rivet blank so that a temperature of a first portion of the composite rivet blank is higher than a temperature of a second portion of the composite rivet blank; and then
finishing the first portion of the composite rivet blank.

3. The method as defined in claim 2, comprising:
heating the composite rivet blank so that the temperature of the second portion of the composite rivet blank is higher than the temperature of the first portion of the composite rivet blank; and then
finishing the second portion of the composite rivet blank.

4. The method as defined in claim 1, comprising:
heating the composite rivet blank using Joule heating while a cooling capacity associated with a first portion of the composite rivet blank is higher than a cooling capacity associated with a second portion of the composite rivet blank; and then
finishing the second portion of the composite rivet blank.

5. The method as defined in claim 4, comprising:
heating the composite rivet blank using Joule heating while the cooling capacity associated with the second portion of the composite rivet blank is higher than the cooling capacity associated with the first portion of the composite rivet blank; and then
finishing the first portion of the composite rivet blank.

6.-13. (canceled)

14. A method for installing a composite rivet using deformation of a composite rivet blank, the method comprising:
inserting the composite rivet blank comprising a composite material into a hole in a part;
heating the composite rivet blank by causing heat to be generated from within a first portion of the composite rivet blank while the composite rivet blank is in the hole and before deforming the first portion of the composite rivet blank; and then
finishing the first portion of the composite rivet blank by deforming the first portion of the composite rivet blank.

15. The method as defined in claim 14, comprising:
heating the composite rivet blank by causing heat to be generated from within a second portion of the composite rivet blank while the composite rivet blank is in the hole and before deforming the second portion of the composite rivet blank; and then
finishing the second portion of the composite rivet blank by deforming the second portion of the composite rivet blank.

16.-18. (canceled)

19. The method as defined in claim 15, comprising cooling the second portion of the composite rivet blank while heat is being generated from within the first portion of the composite rivet blank so that the first portion is hotter than the second portion.

20. The method as defined in claim 15, comprising cooling the first portion of the composite rivet blank while heat is being generated from within the second portion of the composite rivet blank so that the second portion is hotter than the first portion.

21. The method as defined in claim 14, comprising causing heat to be generated from within the composite rivet blank using Joule heating.

22. The method as defined in claim 14, comprising applying ultrasonic energy to one or more tools for finishing the composite rivet blank while finishing the composite rivet blank.

23. An apparatus for installing a composite rivet comprising a composite material, the apparatus comprising:
a first finishing tool configured to be positioned on a first side of a part into which a composite rivet blank has been inserted and finish a first portion of the composite rivet blank;
a second finishing tool configured to be positioned on a second side of the part into which the composite rivet blank has been inserted and finish a second portion of the composite rivet blank; and
a power supply configured to couple with the composite rivet blank when the composite rivet blank is inserted in the part and heat the composite rivet blank using Joule heating.

24. The apparatus as defined in claim 23, wherein the first finishing tool comprises a heat sink configured to selectively change a cooling capacity associated with the first portion of the composite rivet blank.

25. The apparatus as defined in claim 23, wherein the first finishing tool comprises a heat sink that is movable relative to the composite rivet blank to selectively change an amount of surface area of the first portion coupled to the heat sink.

26. The apparatus as defined in claim 24, wherein:
the first finishing tool comprises a ram for applying pressure to the first portion of the composite rivet blank, and, a bucking tool for forming part of the first portion of the composite rivet blank, the bucking tool comprising an opening for movably receiving the ram and the composite rivet blank therein; and
the heat sink comprises the bucking tool.

27. The apparatus as defined in claim 26, wherein the power supply comprises an electric current source electrically coupled to the ram and to the second finishing tool for driving electric current through the composite rivet blank.

28. The apparatus as defined in claim 27, wherein the bucking tool is electrically insulated from the ram.

29. The apparatus as defined in claim 23, wherein the power supply comprises an electric current source.

30. The apparatus as defined in claim 23, wherein the power supply is part of an induction heater.

31. The apparatus as defined in claim 23, wherein:
the first finishing tool comprises a ram for applying pressure to the composite rivet blank, and, a bucking tool for forming part of the first portion of the composite rivet blank, the bucking tool comprising an opening for movably receiving the ram and the composite rivet blank therein; and
the power supply comprises an induction coil embedded into the bucking tool.

32. The apparatus as defined in claim 23, comprising a first induction coil for coupling with the first portion of the composite rivet blank, and, a second induction coil for coupling with the second end portion of the composite rivet blank.

33. The apparatus as defined in claim 23, comprising an ultrasonic generator coupled to the first finishing tool, to the second finishing tool, or, to both the first finishing tool and the second finishing tool.

34. The apparatus as defined in claim 23, wherein:
the first finishing tool comprises a first ram for applying pressure to the composite rivet blank, the first ram being movable relative to a first part of the first finishing tool configured to contact the part; and
the second finishing tool comprises a second ram for applying pressure to the composite rivet blank, the second ram being movable relative to a second part of the second finishing tool configured to contact the part.
